(19) United States
(12) Patent Application Publication
(10) Pub. No.: US 2008/0124673 A1
(43) Pub. Date: May 29, 2008

(54) Device for canal preparation

(76) Inventors: Jean-Marie Badoz, Doubs (FR); Jacques Pernot, Vieilley (FR)

Correspondence Address: Gary M. Cohen, Esq., Strafford Building Number Three, 125 Strafford Avenue, Suite 300, Wayne, PA, 19087-3318, US

(21) Appl. No.: 11/978,797

(22) Filed: Oct. 30, 2007

Related U.S. Application Data
(63) Continuation-in-part of application No. 10/567,169, filed on Feb. 3, 2006.

(30) Foreign Application Priority Data
Aug. 4, 2003 (FR) 03/09593

(51) Int. Cl. A61C 1/12

(52) U.S. Cl. 433/133

(57) ABSTRACT

A canal preparation device includes a contra-angle having a head which is provided with a support for receiving an instrument for treating a canal. The instrument is provided with a shank, and the shank of the canal instrument includes a rotational drive. The base of the head of the contra-angle is provided with a snap-fastening connection which cooperates with the shank of the instrument so that, simply by pushing, the rotational-drive of the shank is engaged in the head, and the shank and the head are snap-fastened together.

### RELATED CASE

This patent application is a continuation-in-part of prior co-pending U.S. patent application Ser. No. 10/567,169, filed Feb. 3, 2006.

### BACKGROUND OF THE INVENTION

The present invention generally relates to devices for the preparation of root canals.

Various instruments for the preparation of root canals are known, including instruments that can be used manually and instruments that can be mechanically driven. Known, mechanically driven instruments can be continuously rotated, or driven in a reciprocating movement. Irrespective of configuration, such instruments can be conventionally used to bore, or otherwise prepare tooth canals.

Instruments operating with a rotational movement are commonly coupled with a contra-angle handpiece for receiving the instrument. Such instruments generally include a shank, which can be defined by known standards such as ISO 1797, and which enters the head of the contra-angle. The head is conventionally provided with an attachment mechanism which allows the shank of the instrument to be removably clamped to the handpiece.

For instruments of this type, the practitioner must remove the instrument from the shank each time the operation to be performed is changed. This leads to the potential of being pricked by the instrument, which in turn leads to an increased risk of injury and the associated risks of contamination of the practitioner and the patient. Because the practitioner comes in direct contact with the instrument when fitting the instrument onto the contra-angle, the risk of contaminating the instrument also increases the risk of microbial growth when treating the tooth canal.

In addition, known attachment mechanisms for clamping an instrument onto the contra-angle are bulky. This, in turn, prevents relatively small-sized heads from being employed, and restricts the visibility available to the practitioner.

### SUMMARY OF THE INVENTION

In accordance with the present invention, these and other disadvantages are overcome by a canal preparation device which includes a contra-angle having a head which is provided with a support for receiving an instrument for treating a canal. The instrument is provided with a shank, and the shank of the canal instrument includes a rotational drive. The base of the head of the contra-angle is provided with a snap-fastening connection which cooperates with the shank of the instrument so that, simply by pushing, the rotational-drive of the shank is engaged in the head, and the shank and the head are snap-fastened together.

Further description of the canal preparation device of the present invention is provided with reference to the detailed description which is provided below, together with the following drawings.

### BRIEF DESCRIPTION OF THE DRAWINGS

FIG. 1 is a side elevational view of the canal preparation device of the present invention.

FIG. 2 is an exploded, elevational view of the canal preparation device shown in FIG. 1, with the shank of the instrument withdrawn from the head.

FIG. 3 is a cross-sectional view of the canal preparation device shown in FIG. 1.

FIGS. 4 and 5 are alternative embodiment, plan views of the canal preparation device, showing different configurations for the snap-fastening connection.

### DETAILED DESCRIPTION OF PREFERRED EMBODIMENTS

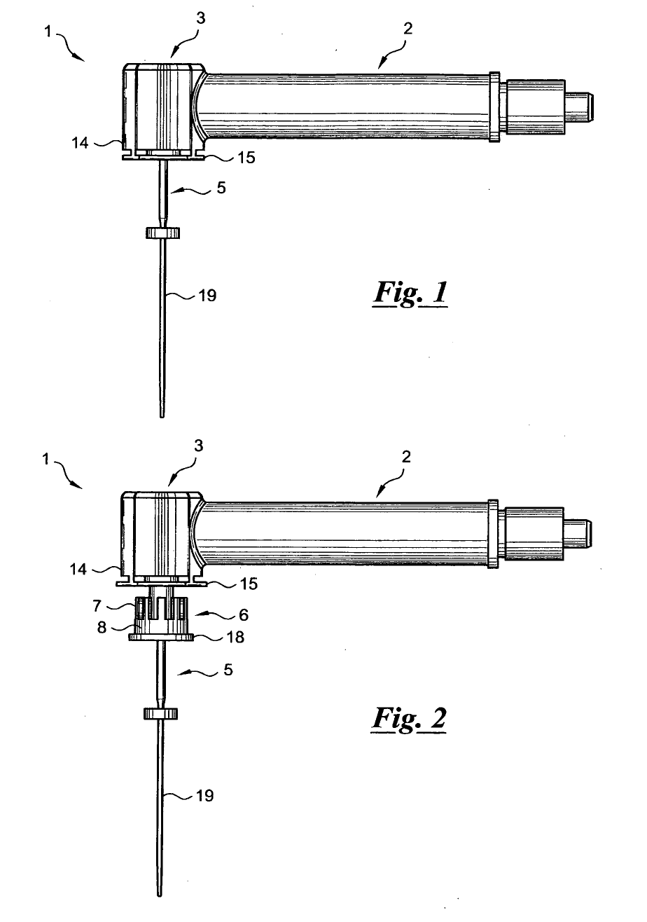

Referring to FIG. 1, the canal preparation device 1 includes a contra-angle 2 having a head 3 which is provided with a support 4 for receiving an instrument 5 for the treatment of a canal. The instrument 5 can be any of a variety of instruments used for such purposes, and is interchangeable responsive to the requirements of the practitioner.

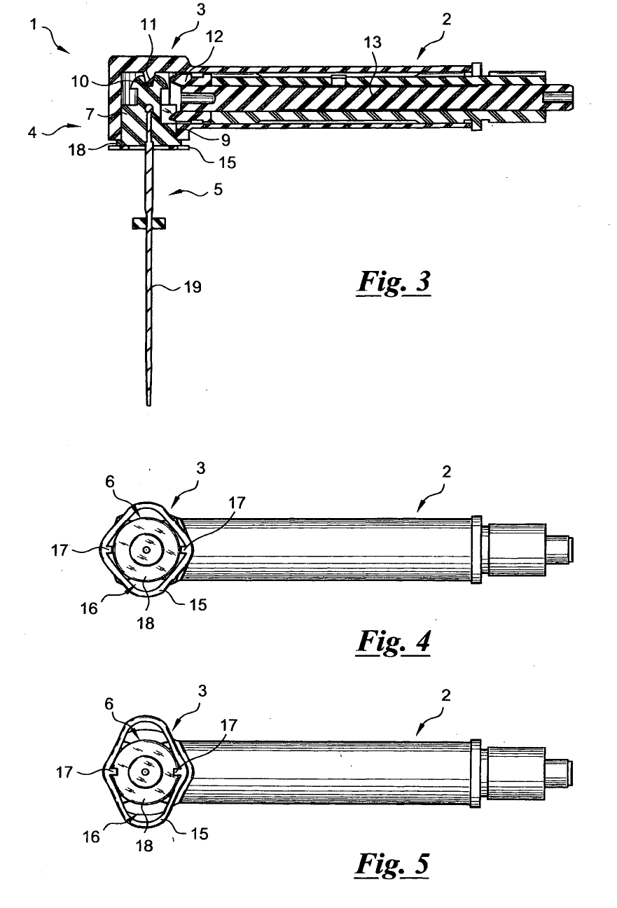

Referring to FIGS. 2 and 3, the instrument 5 is provided with a shank 6 which includes a rotational drive 7. The shank 6 of the instrument 5 cooperates with the head 3 of the contra-angle 2 for supporting the instrument in the head, and includes a smooth surface portion 8 for cooperating with an opening 9 formed in the head 3 to promote rotation of the instrument 5, and a pivot 10 for cooperating with an axle 11 projecting from upper portions of the head to promote rotation of the instrument 5 and to ensure a proper axial thrust of the instrument 5 in the upper portions of the head. The rotational drive 7 of the shank 6 of the instrument 5 cooperates with the output drive 12 of a drive shaft 13 which extends longitudinally through the contra-angle 2 to provide rotational movement for operating the instrument 5. A pinion preferably serves as the rotational drive 7.

The head 3 of the contra-angle 2 has a base 14 which is provided with a snap-fastening connection 15. The snap-fastening connection 15 cooperates with the shank 6 of the instrument 5 to provide desired rotation of the instrument 5 and so that, simply by pressing the structures together, the instrument 5 becomes firmly attached to the head 3 of the contra-angle 2 when the shank 6 is engaged in the head 3.

The head 3 of the contra-angle 2 is made of a flexible material which allows the head 3 to be deformed at the base 14. As a result, when the shank 6 of the instrument 5 is pressed onto the head 3 of the contra-angle 2, a shaped opening 16 (shown in FIGS. 4 and 5) allows the shank 6 of the instrument 5 to pass into the head 3 of the contra-angle 2. In FIG. 4, the opening is substantially rhombic-shaped, and in FIG. 5, the opening is substantially oval-shaped.

To extract the shank 6 and the instrument 5 from the head 3 of the contra-angle 2, all that is required is to compress the head 3 along the long diagonal of the rhombic-shaped opening or along the long axis of the oval-shaped opening to release the snap-fastening connection 15 and to allow the instrument 5 to be discharged from the head 3 by gravity. A pair of fingers 17 projecting from the snap-fastening connection 15 preferably cooperate with a flange 18 provided on the shank 6 to assist in engagement of the shank 6 by the snap-fastening connection 15. In FIG. 4, the fingers 17 are positioned on opposing sides of the short diagonal of the rhombic-shaped opening, and in FIG. 5, the fingers 17 are positioned on opposing sides of the short axis of the oval-shaped opening.

The blade 19 that constitutes the treatment instrument 5 is preferably made of steel because, for instruments intended for only one use, this tends to limit the cost of production. The head 3 of the contra-angle 2 is also preferably made of a material that allows one use only.

The canal preparation device 1 of the present invention exhibits an economic advantage in that the instrument 5 and the head 3 of the contra-angle 2 are made in such a way that the instrument 5 can be used only once. Moreover, the use of the canal preparation device 1 will prevent contamination of the instrument 5 by the practitioner's hand because the instrument 5 is changed by engaging the head 3 of the contra-angle 2 rather than requiring direct contact between the practitioner's hand and the blade 19 of the instrument 5.

It will therefore be understood that various changes in the details, materials and arrangement of parts which have been herein described and illustrated in order to explain the nature of this invention may be made by those skilled in the art within the principle and scope of the invention as expressed in the following claims.

What is claimed is:

1. A canal preparation device comprising a treatment instrument including a shank, and a contra-angle including a head having a support, wherein the shank of the instrument includes a rotational drive, and wherein the head of the contra-angle has a base including a snap-fastening connection cooperating with the shank so that when the instrument is pressed onto the head of the contra-angle, the shank is engaged in the head, and the shank is snap-fastened in the head.

2. The canal preparation device of claim 1 wherein the base of the head of the contra-angle is made of a deformable material.

3. The canal preparation device of claim 2 wherein the base of the head includes a diamond-shaped opening.

4. The canal preparation device of claim 2 wherein the base of the head includes an oval-shaped opening.

5. The canal preparation device of claim 2 wherein deformation of the base of the head allows the shank of the instrument to disengage from the head of the contra-angle.

6. The canal preparation device of claim 1 wherein the instrument is made of steel.

7. The canal preparation device of claim 1 wherein the head of the contra-angle is made of a material that allows one use only.

8. The canal preparation device of claim 1 wherein the rotational drive is a pinion.

9. The canal preparation device of claim 1 wherein the snap-fastening connection further includes an opposing pair of lugs for engaging the shank.
